(19) United States
(12) Patent Application Publication
(10) Pub. No.: US 2006/0099549 A1
(43) Pub. Date: May 11, 2006

(54) Prosthesis

(76) Inventor: Fredrik Engman, Molnylcke (SE)

Correspondence Address: MYERS BIGEL SIBLEY & SAJOVEC, PO BOX 37428, RALEIGH, NC, 27627, US

(21) Appl. No.: 10/517,852

(22) PCT Filed: Jun. 13, 2003
(86) PCT No.: PCT/GB03/02578

§ 371 Date: Sep. 21, 2005

(30) Foreign Application Priority Data
Jun. 15, 2002 (GB) 0213774.3

(51) Int. Cl. A61C 8/00

(52) U.S. Cl. 433/173

(57) ABSTRACT

A prosthetic dental abutment plastics coping configured such that the coping is not premounted to the abutment and is anatomically resemblant to a tooth.

The present invention is directed to a novel dental prosthesis and to a novel method of treatment related thereto.

In particular the present invention relates to a novel dental arrangement, including a novel prosthesis and an implant kit which provides improved treatment.

A dental arrangement will generally comprise an implant which is anchored in the jawbone and protrudes from the gingival region. An abutment is then anchored in the implant and forms the site for reconstruction of the tooth. The tooth reconstruction will often comprise fitting, e.g. cementing, glueing, casting or welding a metal cast onto the abutment and fusing porcelain onto the metal cast.

In a device for the reconstruction of missing or lost teeth, an implant, which ends in the gingival region, is biologically anchored in a jawbone. The implant acts as the anchoring site for an abutment, which in turn forms the reception site for the tooth being reconstructed. The external surface of the abutment is adapted to engage a coping. The coping is made, for example, in an acrylic, which can be supplied in a kit with copings of several suitable anatomical shapes, including, for example, different transgingival margins and cross-sections, heights, diameters and angulations. These copings can form the base for reconstruction of the tooth by, for example, the lost wax-technique. The coping and the abutment can be individually prepared to represent the retention shape of the tooth being reconstructed. The method using a precious alloy abutment is an evolution of the so-called UCLA abutment. The method is also suitable for other metal abutments, preferably in titanium or CoCr, where the casting from the prepared coping is joined to the metal abutment by, for example, laser welding.

The restoration of a tooth on a dental implant can be made using several well known techniques. First there is a choice between so called cemented solutions (porcelain and ceramic cemented on the retention shape of the tooth being reconstructed) or screw retained solutions (porcelain and ceramic on a precious metal coping or bridge screwed onto the abutment). Cemented solutions are mainly based on individually prepared abutments while screw retained solutions generally are based on ready machined components. Secondly if it is a single tooth case compared to a multiple unit case like a partial or bridge, then non-rotational or rotational abutments in relation to the implant need to be considered.

For a cemented solution one of the treatment steps is to manufacture a retention shape of the tooth being reconstructed on the implant. There are several methods and products suitable for performing this part of the treatment. In a case where an especially aesthetic soft tissue margin is desired there are non-precious, e.g. titanium, prepable abutments which can be divided in three groups for single and multiple tooth restorations:

Type I—blanks (i.e. TiAdapt™—Nobel Biocare) or blanks with a plastic sleeve for wax-up (i.e. Preci Disc—CEKA)

Type II—anatomical (i.e. Straight and Angled Esthetic™—Nobel Biocare, FRIALIT®-2 EstheticBase—Friadent, Bio Anatomic Line®—Oraltronics) with prepared margins

Type III—Individually machined non-precious abutments (i.e. Procera® Abutment—Nobel Biocare and other CAD/CAM related techniques from, for example, KaVo- or 3M ESPE-Lava) which also includes producing custom made partials or bridges. semi-atomised methods like the Cresco method.

Another common technique to achieve highly aesthetic soft tissue margins involves cast-on precious metal abutments for single and multiple tooth restorations:

Type IV—Plastic sleeves for wax-up support) i.e. the UCLA-type (UCLA-3i, Auradapt—Nobel Biocare, FRLALIT®-2 AuroBase—Friadent) where the plastic part is pre-mounted on the metallic abutment for each different abutment diameter.

Type V—A similar type as IV is the “Cast-To” Gold Abutments (Sulzer Dental) where the components feature a gold base and a plastic sheath, which is incorporated into the abutment pattern and cast onto the base, and with the option to purchase different plastic sheaths with different emergence profiles.

Type VI—and others for direct wax-up (i.e. Multi Unit abutment, Nobel Biocare).

A common feature with these, Type I-V, is that the connection surfaces with the implant and the abutment screw is machined and therefore exhibits high tolerances and smooth surfaces and includes an extensive assortment. There also exists prepable blanks wholly made in burn-out plastics:

Type VII—a plastic coping, for example with internal octagon MIX, or prepable anatomical abutments like the Castable Abutment System, i.e. C.A.S. Esthetic (Oraltronics). The common feature with these is that the connection surfaces with the implant and the screw will be formed during casting.

In order to provide a solution for different anatomical situations a dental implant system normally comprises of several implant diameters with a corresponding abutment size, i.e. fully castable abutments like the C.A.S. Esthetic (Oraltronics) or for the UCLA-technique represented by the AurAdapt or GCTF of the Branemark System (Nobel Biocare). The general assortment of non-precious metal abutments generally consists of different diameters and in addition also different heights and angulations.

A conventionally known dental arrangement, comprises an implant, abutment and a coping screwed into the abutment.

However, such arrangements suffer from a number of disadvantages. The in situ preparation of titanium abutments (Type I-II above) and copings is time consuming and still requires different diameters, angulations or heights of the copings with a subsequent large assortments of the expensive metal part and high costs for the dental technician work. Specifically the margin on the copings may be difficult to create.

Individually machined abutments like the Procera Abutments (Type III above), are only available from a specific supplier, in this case Nobel Biocare, which normally requires, inter alia, complicated logistics. The original aim with introducing the Type III prosthetic solutions was to use a cheaper and more bio-compatible material then the more conventionally used precious alloys represented by Types IV-VII, and to achieve an absolute passive fit between the prosthetics and the implant by using a machined material and not a cast material, with subsequent problems like porosities and distortion after casting. However, during the last 5-7 years the casting technique for titanium and other related techniques, like laser and X-ray, has considerably improved the casting results, leading to tolerances and a passive fit to the implants equal to conventional precious metal solutions, for example, Type IV-VI and the CAD/CAM solutions, Type III.

The other solutions, Type I-II and Type IV-Type VII, generally requires the clinician or dental technician to hold relative large and expensive stocks of such abutments, especially since there is no simple solution that can be applied to all clinical situations with a choice of non-precious or precious material.

Furthermore, precious metal abutments (type IV-V above) require several manufacturing steps for the dental technician, i.e. transgingival margins and emerging profiles to waxed-up, trimming or milling to obtain optimum angulations. Conventionally known plastic copings offer little or no support in this. However, type V above facilitates a somewhat easier preparation since a few options of emergence profiles are available, but since these have to be purchased separately the overall gain is little.

In order to achieve the right fit, the part, i.e. the abutment, that connects to the implant must be machined, inter alia, to avoid voids between the parts and a subsequent microleakage. Thus, the type VII abutment is unsuitable for use with the existing casting techniques.

Another reason for having a machined abutment, and not a cast abutment, connecting to the implant, is that the abutment screw may require a specific preload to withstand the forces on the prosthetic construction in function. This can only be achieved if the seating surface of the screw on the abutment and the connecting area between the implant and the abutment, are both machined.

A poor fit between the abutment screw and the connecting area lead to rotational movements and can also cause screw loosening. Indeed, some of the most advanced abutment connections prove to be impossible to cast.

In summary, the problem with prior art arrangements is that, inter alia, they are generally not adapted to be worked up by a dental technician in a local laboratory with common laboratory equipment or, alternatively, the dental technician will have an extremely wide range of prostheses to have to choose from.

We have now developed a novel dental prosthesis arrangement which overcomes or mitigates the disadvantages of prior art approaches. In particular we have developed a novel dental prosthetic abutment and a novel coping, which enables an improved dental prosthesis to be prepared.

Thus, according to a first aspect of the invention we provide a prosthetic dental abutment coping characterised in that the coping is adapted to be rotatably mounted and is anatomically resemblant to a tooth.

Of course; it is within the scope of the present invention for the coping to be resemblant of a tooth prosthesis or prepared tooth.

It is an important aspect of the present invention that the coping is adapted to be rotatable. The provision of a rotatably mounted coping is advantageous in that, inter alia, it provides the technician with 360 degrees of freedom. Existing copings are provided in premounted form, which means that they are generally cylindrical and therefore lack important anatomical features, which presents difficulties to the technician in working up the coping.

In a further preferred embodiment the coping may be adapted to form a snap fit with the abutment. The term snap fit will be well understood by those skilled in the art. Thus the term should be construed as meaning any conventional, e.g. non-screw fitting, whereby the abutment and the coping can form a snug, engaging fit with one another. Other such similar terms which should be included in the term snap fit are, e.g. snug fit, push fit, etc. Another method is to fit the coping to an abutment by means of the pre-load, e.g. from a screw.

The anatomically resemblant copings of the invention are advantageous in that, inter alia, they enable the dental technician to be provided with a limited selection of copings. Thus, preferably the novel copings of the invention may anatomically resemble a molar, a premolar a canine or an incisor, resulting in the achievement that only a limited assortment of abutments is required, e.g. preferably four for each size per implant connection geometry.

Thus, in a further aspect of the invention we provide a kit of parts comprising at least an abutment, e.g. a dental abutment, and a selection of copings as hereinbefore described.

Preferably, the kit of parts comprises a plurality of copings and, optionally, a plurality of abutments. In a further preferred embodiment the kit of parts as hereinbefore described may also comprise one or more dental implants.

The coping, the abutment and/or the arrangement as hereinbefore described are each novel per se.

Thus, according to a further aspect of the invention we provide a dental abutment which is adapted to form a rotatable fit with a coping as hereinbefore described.

In an especially preferred aspect of the invention the abutment may be provided with means for forming a stable retraining joint with the coping. Preferably, the coping may also comprise corresponding means for forming a stable retaining joint with the abutment.

Conventionally known retaining means may be used. However, in one embodiment, the stable retaining means may comprise an annular recess and an annular lip adapted to engage with one another. Thus, the stable retaining means may comprise an abutment provided with an annular lip and a coping provided with an annular recess. In an alternative and preferred embodiment the stable retaining means may comprise an annular lip/press fit engagement, or “snap-on” arrangement.

However, in the most preferred embodiment the abutment will be provided with an annular recess and the coping may be provided with an annular lip.

For the reseating of a cast on an abutment the aforementioned retentive feature should not interfere with the abutment so that is why it must be able to be removed and/or deactivated, which, prior to the present invention, has substantially always been the case for non-precious alloys intended to be joined to the abutment by other means than being directly cast on to the abutment. The annular lip on the coping, hereinbefore described, can therefore be removed prior to or after casting, whichever is considered to be the most convenient.

The reseating of the cast can be facilitated by involving removable “scotch” tape or paint which during casting forms a base for the retentive feature of the snap-on function but if placed on the abutment easily can be removed prior to reseating.

In a device for the reconstruction of missing or lost teeth, an implant, which ends in the gingival region, is biologically anchored in a jawbone. The implant acting as the anchoring site for an abutment, which in turn forms the reception site for the tooth being reconstructed. The external surface of the abutment is adapted to the internal geometry of a coping and there are means to obtaining a stable join between the abutment and the coping during the preparation of the restoration. The coping is made in an acrylic or other suitable “burn-out” material, which can, optionally, be supplied in a kit with copings of several suitable anatomical shapes, including, for example, different transgingival margins and cross-sections, heights, diameters and angulations, which form the base for reconstruction of the tooth by, for example, the lost wax-technique. The coping and the abutment can be individually prepared to represent the retention shape of the tooth being reconstructed. The method using a precious alloy abutment is an evolution of the so-called UCLA abutment. The method is also suitable for other metal abutments, preferably in titanium or CoCr (cobalt chrome), where the casting from the prepared coping is joined to the metal abutment by for example laser welding.

In addition, to fasten the cast by laser welding or casting gold onto gold, we have found it possible to glue a titanium cast on to a titanium base or a gold cast on to a titanium base. Although a variety of glues may be used, one example of an appropriate glue is a medical grade epoxy resin. The procedure is such that the cast can be glued on to e.g. a metal base in the laboratory prior to or after porcelain bonding, under conditions that are very suitable but also convenient and familiar for the laboratory technician. Alternatively, a plastics base may, be used.

The coping may be prepared from a variety of materials such as a so-called “burn out” plastic or wax material, which are familiar to dental technicians in creating cast metal restorations using the lost-wax technique. A suitable plastic material is LEXAN 141R (in a clear 111 grade) available from General Electric. This material can be ground or otherwise machined to a desired customised shape.

According to a further aspect of the invention we provide a method of preparing a dental prosthesis which comprises the use of a kit or an arrangement as hereinbefore described

The arrangement and the novel copings and/or the kit of the invention are advantageous in that, inter alia, they:
Allow easy, fast and flexible preparation by the technician or the clinician by providing customised optimal near finish line or transgingival margin, transgingival cross-sections, angulation and emergence profile as well as avoiding or minimising any trimming of metal since the major part of the trimming can be made in the plastic.
Bring implantology closer to conventional dentistry by providing a much easier and faster way to prepare the retention shape of a tooth being reconstructed.
Provide a predictable interface between the abutment and the implant and the abutment screw providing stable preload and tight fit between the implant and the abutment.
Require no or little needs for different abutment heights or angulations reflecting in a low overall system stock level for the individual clinician, technician, clinic, hospital and even the manufacturer.

One advantage of the invention is that is possible to make a gold restoration on a non-precious metal base, which has advantages when no titanium casting machine is available. For example, the technician does not store a range of porcelains suitable for titanium. The base is also less expensive but the restoration uses the most common material which is gold. It is also possible to make a full titanium restoration, for example, without having the need for a laser welding equipment. The gluing can take place preferably in the laboratory, which means that a much more controlled and advanced procedure can be carried out compared to gluing conducted in the oral cavity. The same components can be used for all described fastening methods providing a large flexibility of restoration options.

A further option which is within the scope of the present invention is to have a plastic abutment base in addition to a titanium, gold or ceramic restoration. Such an option is advantageous because, inter alia, the restoration will be extremely inexpensive to use, although in some instances it may be less exact since there is not a machine fit. This would provide a plastic coping on a plastic base and allow casting of the whole preparation in one piece in precious or non-precious material. Thus, no welding of the parts would be necessary, e.g. of titanium. I don't think this has been implemented even though you have introduced a plastics base for the scanning.

Thus according to a yet further aspect of the invention we further provide a method of preparing a dental prosthesis which comprises producing a single cast comprising a dental abutment and a prosthesis which is anatomically resemblant to a tooth.

We further provide a kit of parts comprising at least a selection of copings one or more plastics dental abutments.

The invention also provides the advantage of a method which is also suitable for other metal abutments, preferably in titanium, where the casting from the prepared coping is joined to the metal abutment by for example laser welding. Since titanium is a biocompatible material compared to gold this is a preferable solution as well as for patients allergic to gold. CoCr is also a metal that can be used according to the principles of titanium.

The method can be incorporated and used with all major existing implant systems. The plastic coping and the abutment can also be used together with CAD/CAM techniques and relative methods, where it provides faster preparation. Furthermore, it is within the scope of the present invention for the copings of the invention to be used in a method comprising scanning or other type of shape transfer on to a CAD/CAM system. The coping may then be further processed to create a dental restoration. The shape transfer in this aspect of the present invention is not dependent upon, inter alia, the base material used, e.g. titanium, gold, ceramic, ceramic composites, plastic resin, Co/Cr etc. In addition, the shape transfer is further not dependant upon whether or not the coping is mounted on an abutment or any metal or plastic base or alternatively whether it is made to fit directly onto an implant.

The method can provide a business solution where the technique is provided to several manufacturers by adjusting the abutment interface to the specific implant system and is especially effective on implant level since it will exclude the expensive abutment but still the solution can be adapted to abutment level.

In a further aspect of the invention we provide a method of preparing a dental prosthesis which comprises the use of a glue to join a cast made of a precious or non-precious metal to a base.

In this aspect of the invention the method may comprise gluing to a metal base, e.g. an metal portion of an abutment connection, or, alternatively, a plastics base.

The invention will now be described by way of example only and with reference to the accompanying drawings, in which

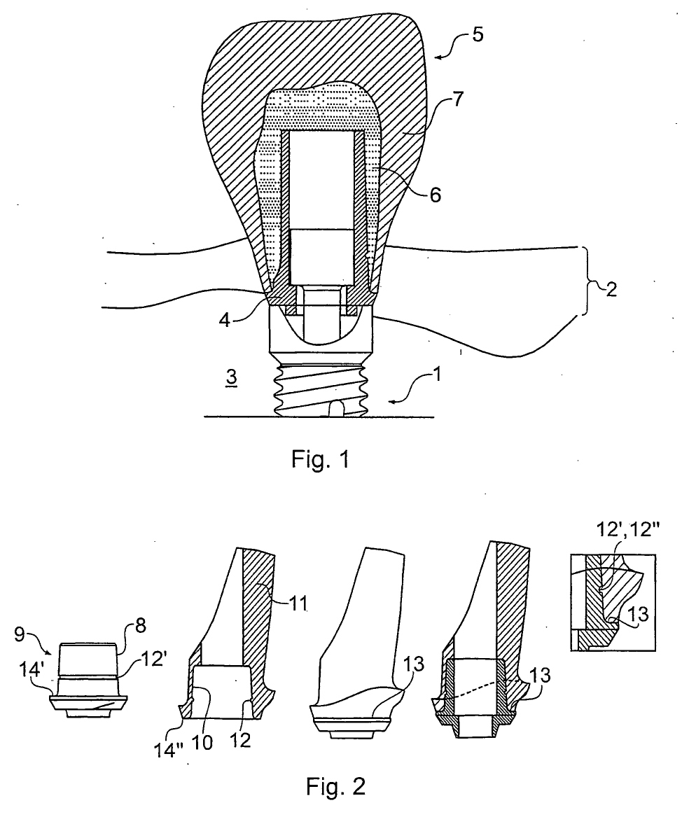

FIG. 1 illustrates an implant with abutment and the restored crown in bone;

FIG. 2 illustrates an abutment and plastic coping designs with retentive feature;

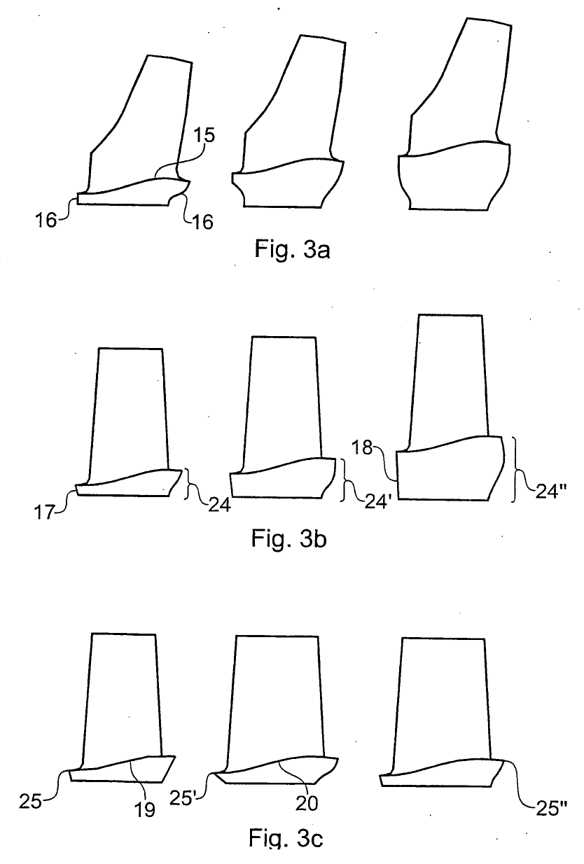

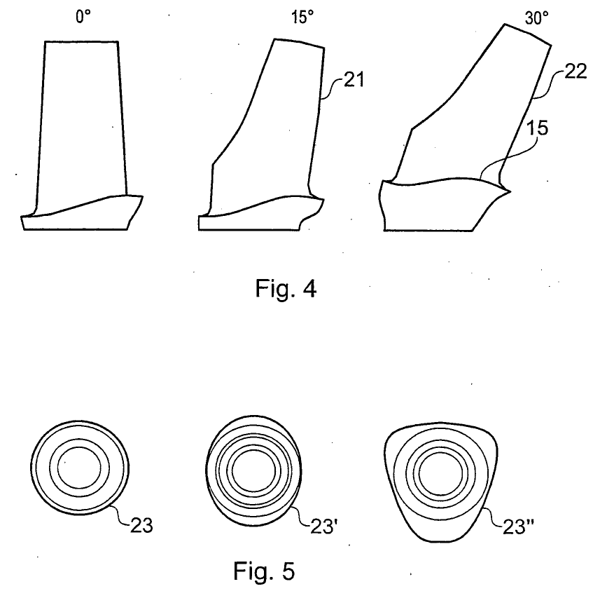

FIGS. 3-4 illustrate plastic coping designs including different transgingival height, angulation emergence profile;

FIG. 5 illustrates the transgingival cross-sections of plastic coping

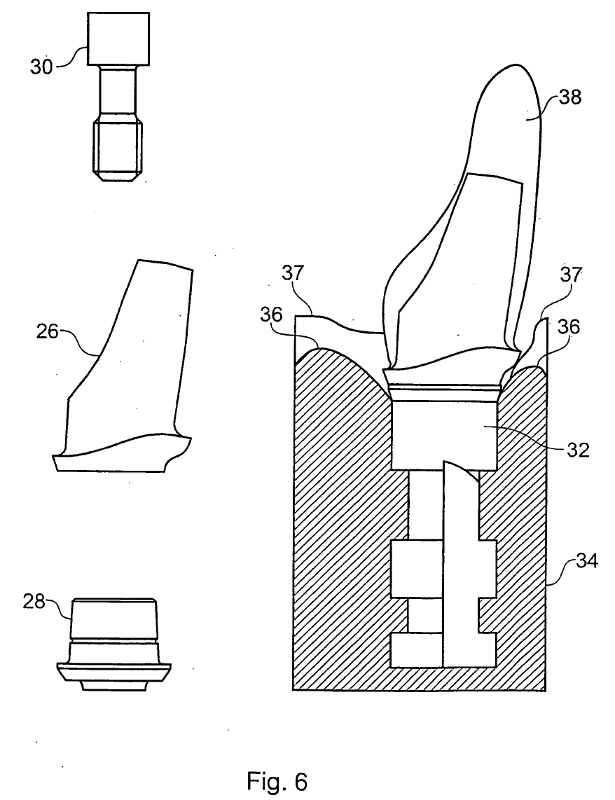

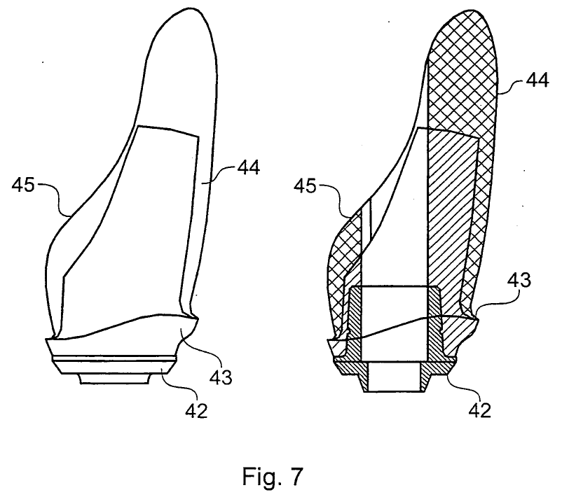

FIGS. 6-7 illustrate restorative procedures with precious metal abutment;

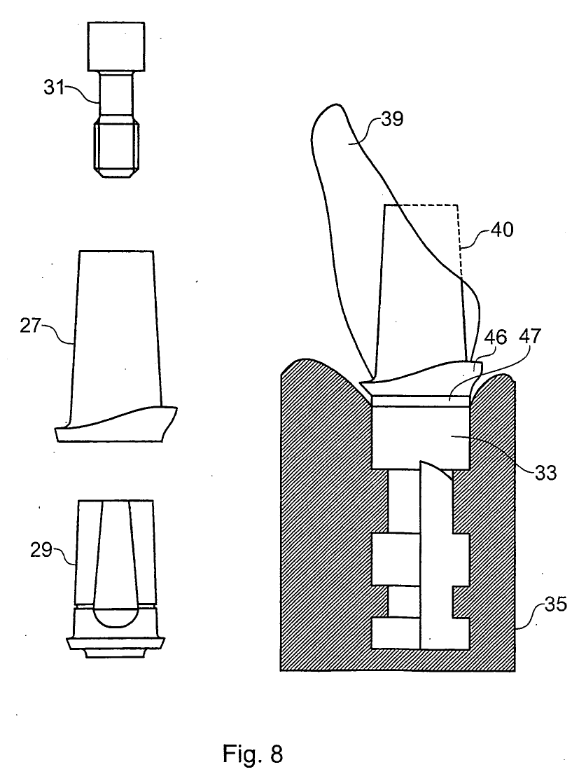

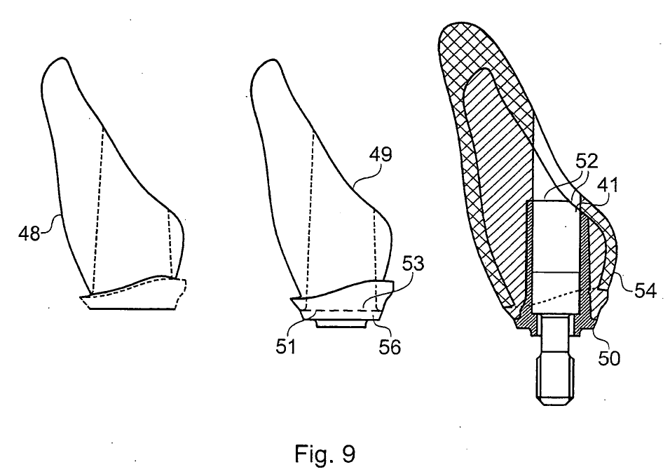

FIGS. 8-9 illustrate restorative procedures with non-precious metal abutment including joining;

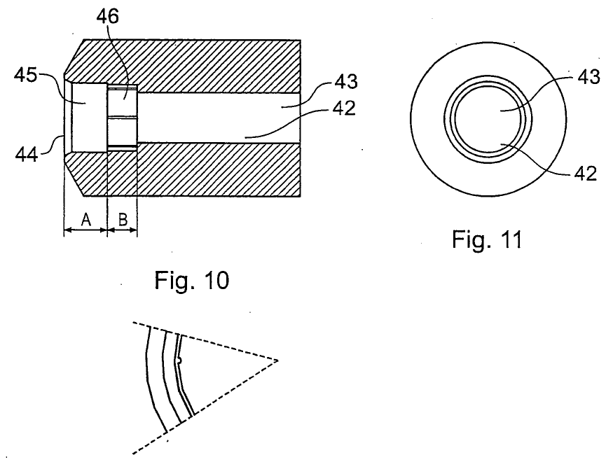

FIG. 10 is a cross sectional view of plastics coping;

FIG. 11 is a plan view of a plastics coping;

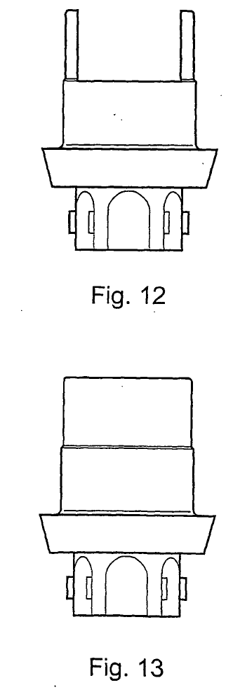

FIG. 12 is a perspective representation of a titanium abutment connection; and

FIG. 13 is a perspective representation of a gold abutment connection.

Referring to FIG. 1; for the reconstruction of missing or lost teeth, an implant (1), which ends in the gingival region (2), is biologically anchored in a jawbone (3). The implant acting as the anchoring site for an abutment (4), which in turn forms the reception site for the tooth being reconstructed (5) with a metallic cast (6) on the abutment (4) and porcelain (7) fused on the cast (6). After placement of the implant an impression is taken for replicating the position of the implant prior to the restorative work. Impression on fixture level is an increasingly used method for reasons like accuracy, price, earlier loading, one-stage surgery. A so called master cast or stone model is made with a fixture replica providing a base for the continuing restoration. The restorative solution according to the invention is a cemented solution for both single tooth solutions and multiple unit restorations, even though excess holes in an appropriate position can permit screw retained retrievability.

Referring to FIG. 2; the external surface (8) of the abutment (9) is adapted to the internal geometry (10) of a plastic coping (11) according to the invention and FIG. 2. There are means (12′, 12′) to obtain a stable and retaining joint (13) with high tolerances and fit between the abutment and the coping mating surfaces (14′,14″) during the preparation of the restoration. This retention can for example be obtained by means of friction, mechanical locking, temporary cement, removable scotch, removable paint or combination thereof.

Referring to FIGS. 3 and 4; a set of burn-out plastic copings, with anatomical transgingival margins 15 that follow the mesial (16′) and distal contour (16″). A set includes different anatomical copings for different anatomical positions like the anterior mandible (narrow teeth), the anterior maxilla (angulated teeth) or the posterior regions (larger emergence profiles and diameters). The anatomical designs include copings with low margins (17) to high margins (18), FIG. 3b, narrow margins (19) or wide margins (20), FIG. 3c, and angulated copings with angulations up to 40 degrees, but preferably 15° (21) to 30° (22), FIG. 4. Other anatomical design features are different transgingival cross-sections FIG. 5 with round (23), oval (23′) and triangular (23″), different heights (24, 24′, 24″), FIG. 3b, and emergence profiles (25, 25′, 25″), FIG. 3c. The heights are preferably from 1-5 mm. Each set can be produced from the same mould and even held together by the spurs in its as delivered condition. Together with the anatomical copings proper blanks and/or instruments can be included in the kit and on spur. With each abutment, which for example is made in a precious metal or non-precious like titanium, the clinician can be provided with the whole range of copings to choose from due to the effective production. Thus the set can be included with each abutment, but the copings can also be provided separately from the abutments, for example sorted by type but still they form a set of copings available for the clinician. The number of copings is below 30 and preferably below 20.

Referring to FIGS. 6 to 9; the coping (26, 27) is in most cases fitted by the dental technician on to an abutment (28, 29) by the means of an abutment screw (30, 31), FIGS. 6, 8, on a fixture replica (32, 33) of the master cast (34, 35). Once in the appropriate surrounding with bone tissue levels (36) and/or soft tissue levels (37) the preparation starts with forming the reconstruction, preferably with wax (38, 39) and the subsequent lost wax-technique. If necessary the coping can be individually milled and trimmed (40), which requires that the coping is rotationally stable on the abutment as well as being able to with stand the bending forces. Also the abutment can be adjusted and trimmed (41), FIG. 9, during this work, which normally is the case when an angulated abutment is needed.

Referring to FIGS. 10 and 13, the inner region of a plastic coping (42) is provided with a central conduit (43). One end (44) of the conduit (43), is provided with an annular shoulder (45) (depicted as region A), the shoulder itself being provided with a plurality of circumferential ridges/lips (46) (preferably 6) (depicted as region B). The ridges/lips (46) comprise a resilient plastics material which can resiliently flex so as to create a compression through press fit over the corresponding top part of an abutment. It is not necessary for region A to be provided with a press fit since it is mainly there to provide support rather than to form a fixing connection.

Furthermore, it is important that the titanium abutment (depicted in FIG. 12) may have two regions (wings) of the upper part of the abutment. In addition, some of the annular ridges/lips of the coping may also be removed in order to avoid fitting problems after casting.

Abutment bases according to the invention may be made of a variety of rigid dental materials, preferably metals such as dental gold, as can the substructure of the restoration. Depending on if it is a precious metal, FIG. 6-7, or non-precious, FIG. 8-9, abutment the procedures of the casting and forming of the metal base for the porcelain are to some extent different.

### EXAMPLE 1

Casting with Precious Metal Abutment

After the preparation, the coping (43), the wax (44) and the abutment (42) are cast by conventional methods, for example the lost wax process as previously said, to form a solid body (45). The preparation has no limitations and the copings can be used when producing single crowns, partials or full bridges as well as for ball attachments according to any existing common procedures. This technique can be used also with non-precious metals but the bonding between the metal abutment and that cast will be poor with the existing casting techniques and metals. However there is another solution for non-precious materials, like titanium, as described below.

### EXAMPLE 2

Casting with Non-Precious Metal Abutment

When using a non-precious metal like titanium in the abutment (29) the preparation (39,46, 48) is lifted off from the abutment (47) and then the preparation is cast individually according to suitable techniques. To be able to re-seat the cast (49) on the abutment (50) the retention function of the retentive element (12″) must be removed which is done either before casting on the preparation (48) or after casting (49) with a suitable method and/or tool. If it is an annular lip on the coping or on the cast the lip can be removed by a burr or similar tool. If it is a scotch then it is just pealed off. If it is a paint, the paint is removed by existing methods. When this is done the solid non-precious preparation (49) can be placed and joined to the abutment (50) by means of for example laser welding the contacting surfaces (51, 51′). To increase the strength, or as alternative joining methods, cementation can be used or an extra weld can be placed on the upper coronal part of the abutment (52). The laser weld (53) is easily polished to avoid irregularities in order to avoid plaque retention

After the preparation of the metallic core (49+50) of the reconstructed tooth (5) the baking of the porcelain (I) can take place on the individually made or customised abutment containing the metal cast (II) joined to the abutment (III). Again the preparation has no limitations and the copings can be used when producing single crowns, partials or full bridges as well as for ball attachments, even though for some rare cases the titanium cast is still not suitable since passive fit of for example a cast bridge might only be achieved by sectioning the final cast and subsequent joining by laser or other appropriate method. The preferred solution with the method of casting in a non-precious metal like titanium is to fabricate an individual abutment which than can be a base for single crowns, partials or full bridges as well as for ball attachments.

### EXAMPLE 3

Gluing a Precious or Non-Precious Abutment on to a Non-Precious Metal Abutment

When using glue, for example epoxy, there is another method to prepare the customised abutment where by the solid precious or non-precious preparation (49) is glued on to the non-precious base. This can be done prior to or after the porcelain firing depending on the glue. The glue is for example applied on the external surface (8) and the mating surface (14) of the abutment before mating the preparation (49) with the metal base (56). After the mating the assembly is cured in for example a furnace in inert or normal environment.

1. A prosthetic dental abutment plastics coping configured such that the coping is not premounted to an abutment and is anatomically resemblant to a tooth.

2. A prosthetic dental abutment plastics coping according to claim 1 wherein the coping is adapted to be rotatably mounted.

3. A prosthetic dental abutment plastics coping according to claim 1 wherein the coping is resemblant of a tooth prosthesis.

4. A prosthetic dental abutment plastics coping according to claim 1 wherein the coping is resemblant of a preprepared tooth.

5. (canceled)

6. A prosthetic dental abutment plastics coping according to claim 2 wherein the coping is rotatably mounted with 360 degrees of freedom.

7. A prosthetic dental abutment plastics coping according to claim 1 wherein the coping is adapted to form a snap fit with the abutment and withstand rotational forces during the making of the tooth preparation.

8. A prosthetic dental abutment plastics coping according to claim 1 wherein the coping is resemblant to a molar.

9. A prosthetic dental abutment plastics coping according to claim 1 wherein the coping is resemblant to a premolar.

10. A prosthetic dental abutment plastics coping according to claim 1 wherein the coping is resemblant to a canine.

11. A prosthetic dental abutment plastics coping according to claim 1 wherein the coping is resemblant to an incisor.

12. A prosthetic dental abutment plastics coping according to claim 1 wherein the coping comprises a “burn out” plastic or wax material.

13. A prosthetic dental abutment plastics coping according to claim 12 wherein the plastic material is LEXAN 141.

14. A dental prosthetic assembly comprising: a dental plastics abutment which is adapted for implantation in a patient; and a prosthetic dental plastics coming that is anatomically resemblant to a tooth, wherein the abutment is adapted to engage the coping and the coping is not premounted to the abutment.

15. A dental prosthetic assembly according to claim 14 wherein the abutment forms a rotatable fit with the coping.

16. A dental prosthetic assembly according to claim 14 wherein the abutment is provided with means for forming a stable retraining joint with the coping during the preparation thereof.

17. A dental prosthetic assembly according to claim 16 wherein the coping comprisies corresponding means for forming a stable retaining joint with the abutment.

18. A dental prosthetic assembly according to claim 17 wherein the stable retaining joints of the abutment and the coping comprise an annular recess and an annular lip adapted to engage with one another.

19. A dental prosthetic assembly according to claim 18 wherein the-abutment is provided with the annular lip and the coping is provided with the annular recess.

20. A dental prosthetic assembly according to claim 18 wherein the abutment is provided with the annular recess and the coping is provided with the annular lip.

21. A prosthetic dental abutment plastics coping according to claim 1 wherein the coping comprises a transgingival margin.

22.-55. (canceled)
